(19) United States
(12) Patent Application Publication
(10) Pub. No.: US 2012/0034814 A1
(43) Pub. Date: Feb. 9, 2012

(54) RECEPTACLE CONNECTOR

(75) Inventors: Ting-Chang TSENG, Taipei Hsien (TW); Yi-Tse HO, Taipei Hsien (TW)

(73) Assignee: MOLEX INCORPORATED, Lisle, IL (US)

(21) Appl. No.: 13/204,943

(22) Filed: Aug. 8, 2011

(30) Foreign Application Priority Data
Aug. 6, 2010 (TW) 99215126

(51) Int. Cl. H01R 24/00; H01R 3/00

(52) U.S. Cl. 439/490; 439/660

(57) ABSTRACT

A receptacle connector includes a housing and a cage. The housing comprises a base and two arms that extend integrally from the two sides of the base. A tongue extends from the base. Terminals are mounted on the tongue. The cage includes a deflector and is assembled to the housing so as to form a socket. One arm includes a light channel and the deflector extends into the light channel. The light channel has a light inlet and a light outlet that form an intersection angle and that are in communication with each other and an exit. In operation, light enters the light inlet, is reflected off the deflector and is directed toward the exit.

### RELATED APPLICATIONS

This application claims priority to Taiwanese Application No. 99215126, filed Aug. 6, 2010, which is incorporated herein by reference in its entirety.

### TECHNICAL FIELD

The present invention relates to a receptacle connector, more specifically to a connector suitable for providing a visual indication effect.

### BACKGROUND ART

The Republic of China patent certificate number M285100 (Application Number 94211887) discloses a known electric connector with a reflector, wherein the reflector is placed above a light emitting diodes placed near the lower front end of a plastic body. The reflector has a first and a second reflecting surface connected to each other. Assembly pieces are placed inside the reflectors that are assembled jointly with the assembly holes on the two sides of the body. Various light emitting diodes are respectively placed below the sunken slots on the front ends of the two sides of the plastic body. A transparent light guide piece is placed on the front end of the front side of the sunken slot. With this, the light emitted by the light emitting diodes can be admitted by the light guide piece after being appropriately reflected by the first and second reflecting surfaces, thus achieving the purpose of easy assembly and highly efficient reflection of a light source. However, the reflector of the aforementioned electric connector needs to be made as an extra piece, for which extra assembly, composition and procedures are required.

### SUMMARY OF THE INVENTION

In an embodiment there is a receptacle connector that includes a housing, which comprises a base and two arms that extend integrally from the two sides of the base. The base extends into a tongue; a plurality of terminals, which are placed on the tongue; and a cage, which is assembled on the housing. The housing combines with the cage to form a socket on the front end; wherein at least one arm of the housing has alight channel. The light channel has a light inlet and a light outlet that form an intersection angle and that are connected to each other. The light inlet is in communication with an exit. At the intersection angle between the light inlet and the exit, there is a deflector that extends from the cage. The deflector has a deflecting surface that directs light from the light inlet toward the exit. In an embodiment, the receptacle connector can be part of a system that includes a circuit board upon which the receptacle connector is mounted.

### BRIEF DESCIRPTION OF THE DRAWINGS

The present invention is illustrated by way of example and not limited in the accompanying figures in which like reference numerals indicate similar elements and in which:

FIG. 1 is a perspective exploded view of an embodiment of a connector system;

FIG. 2 is a perspective view of an embodiment of a connector system;

FIG. 3 is another perspective view of the embodiment depicted in FIG. 2;

FIG. 4 is an elevated front view of the embodiment depicted in FIG. 2;

FIG. 5 is an elevated side view of a cross-section of a connector taken along the line 5-5 in FIG. 4;

FIG. 6 is an elevated side view of a cross-section of a connector taken along the line 6-6 in FIG. 4

FIG. 7 is a perspective view of an embodiment of a connector system; and

FIG. 8 is a perspective view of an embodiment of a connector system with a partial cut-away.

### DETAILED DESCRIPTION OF THE PREFERRED EMBODIMENTS

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

The depicted embodiments provide a beneficial effect in that the deflector is integrally formed with the cage. Therefore, there is no need for an independently made deflector, nor is there any need for extra assemblies, structures and procedures. Compared with known structures, this can simplify assembly procedures and reduce manufacturing cost.

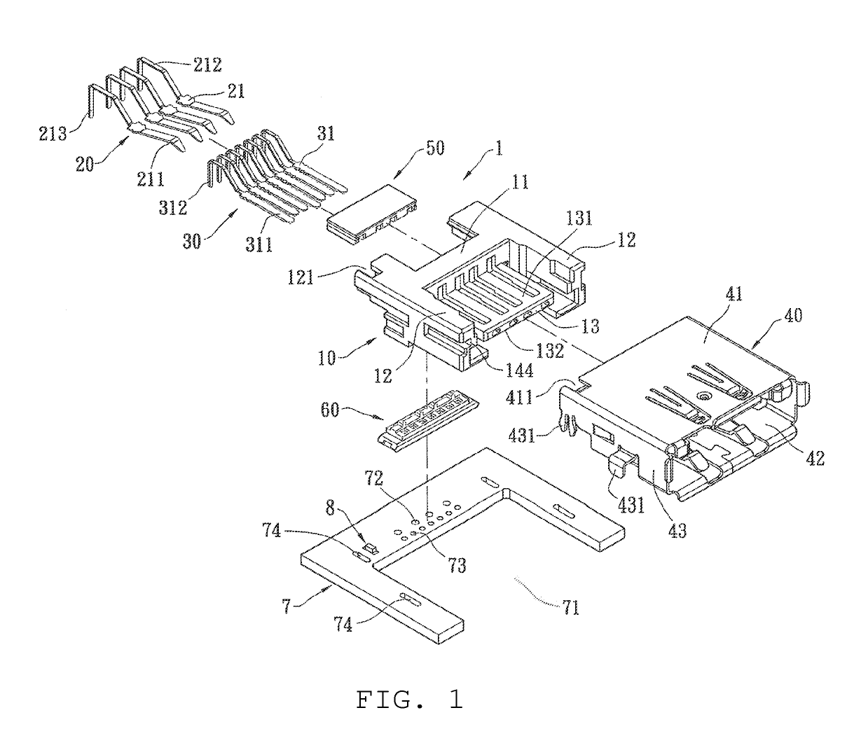

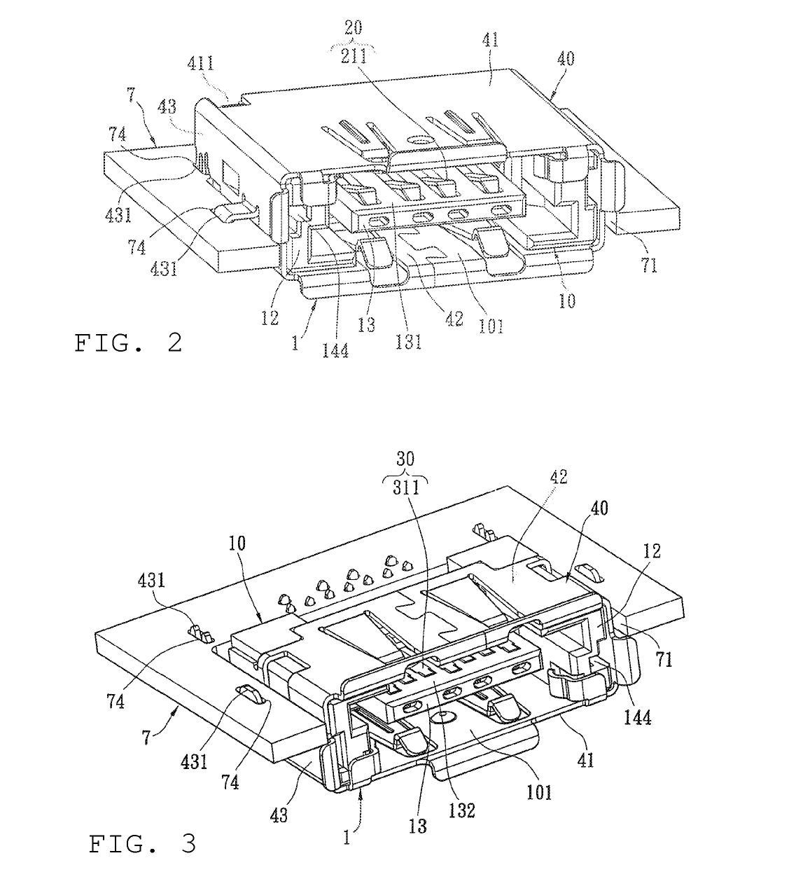

Please refer to FIG. 1 to FIG. 3. Receptacle connector 1 includes an housing 10, a first terminal set 20, a second terminal set 30, a cage 40, a first positioning block 50 and a second positioning block 60. The housing 10 has a base 11 and two arms 12 that are integrally formed in and extend from the sides of base 11. The base 11 extends forward to form a tongue 13 and tongue 13 has a first surface 131 and a second surface 132 opposite each other.

Each of first terminal set 20 and second terminal set 30 has a plurality of first terminals 21 and second terminal 31, which are made of electro-conductive metal materials and which are used to transmit different signal protocols. Wherein, each of the first terminals 21 has a first contact part 211 extending forward and the tail end of first terminals 21 comprises an extension part 212 that is connected to the first contact part 211 and that extends backward, as well as the first welded part 213 that extends downward from the end of the extension part 212. Each of the second terminals 31 has a second contact part 311 that extends forward and the tail end of second terminals 31 has a second welded part 312.

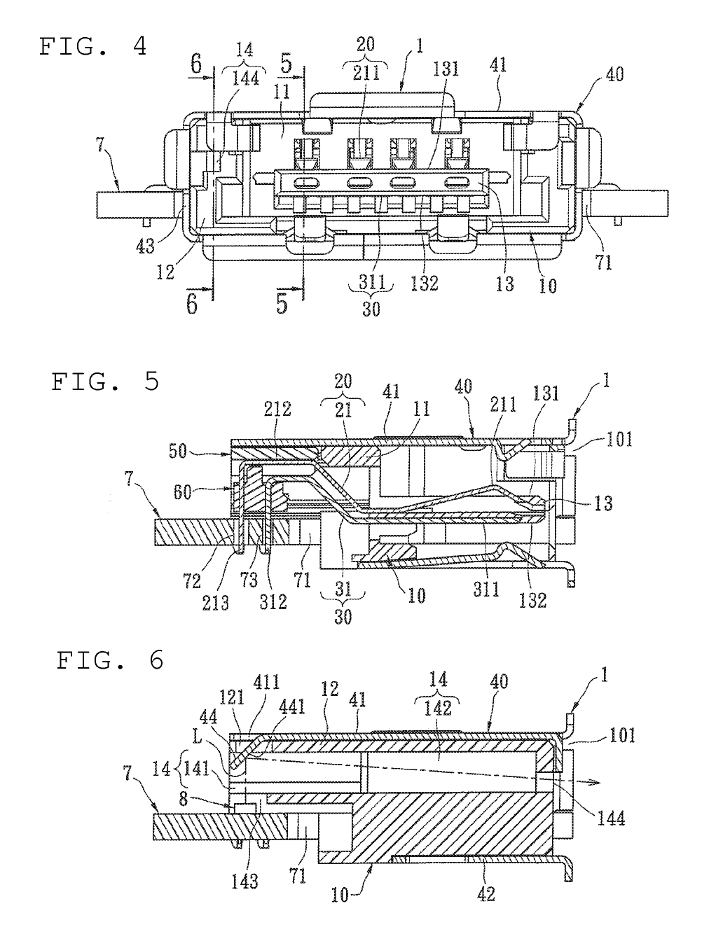

The first terminal set is placed on first the surface 131 of tongue 13. The second terminal set 30 is placed on second surface 132 of tongue 13 (please refer to FIG. 4 and FIG. 5), thus allowing first and second terminals 21 and 31 to be placed on the tongue 13. The aforementioned first and second welded parts 213 and 312 extend out of the installation body 10. The aforementioned first and second contact parts 211 and 311 are correspondingly exposed on first surface 131 and second surface 132 of the tongue 13.

As depicted, first terminal set 20 is configured to comply with Universal Serial Bus (USB) 2.0 signal transmission protocol and second terminal set 30 is a terminal set that complies with External Serial Advanced Technology Attachment (eSATA) signal transmission protocol but they are not limited thereby. Of course, in a modified embodiment, first terminal set 20 can also directly be replaced by a terminal set that complies with USB 3.0 signal transmission protocol, thus being able to transmit USB 3.0 signals.

The cage 40 can be made of metal materials and is slid over and assembled on through outside of housing 10. The cage 40 combines with housing 10 to form a socket on the front end that is aligned with an insertion direction. The cage 40 comprises a roof 41, a bottom 42 and two side walls 43 that are connected to the two sides of roof 41 and bottom 42. The two side walls 43 respectively have an anchor pin 431 that extends downward.

The first positioning block 50 and second positioning block 60 are assembled on the rear part of housing 10 and are respectively used to position first and second terminals 21 and 31 (please refer to FIG. 5). The first positioning block 50 positions extension part 212 on the rear and of the first terminals 21 and the second positioning block 60 positions welded parts 213 and 312 of the terminal sets 20 and 30, in order to achieve the effect of positioning and preventing them from contacting each other.

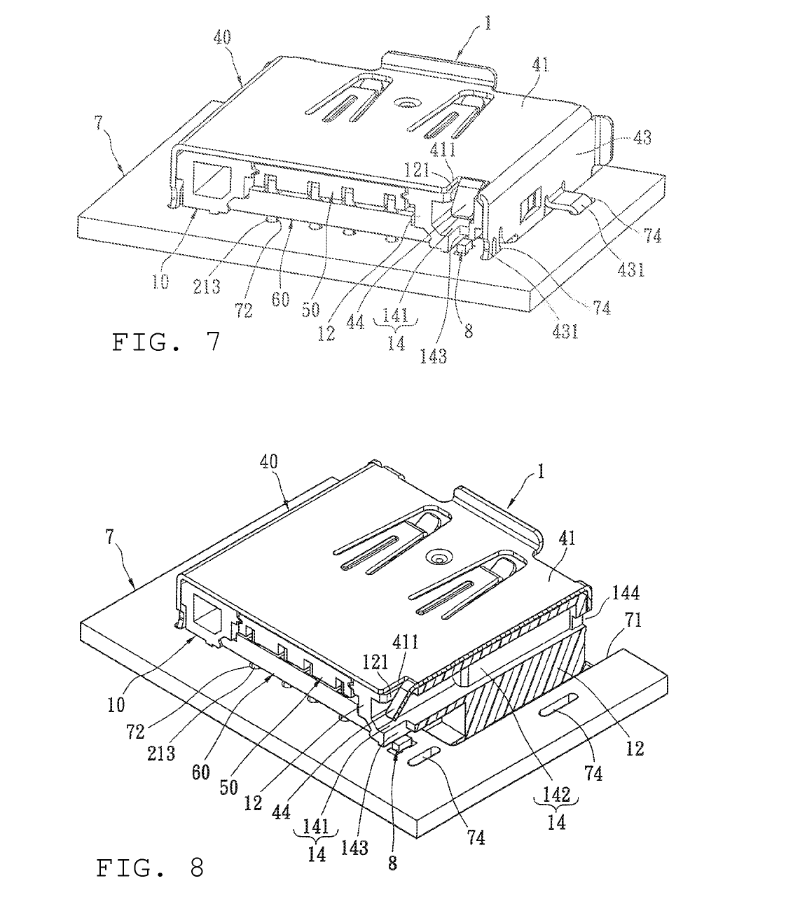

In addition, please refer to FIG. 2, FIG. 4, FIG. 6, FIG. 7 and FIG. 8. One arm 12 of the housing 10 has alight channel 14. The light channel 14 has a light inlet 141 and a light outlet 142 that form an intersection angle and that are connected to each other. The light channel 14 can be “L” shaped, meaning that the intersection angle can be about 90°. The light inlet 141 has an entrance 143. The light outlet 142 has an exit 144 toward the direction of socket 101. At the intersection angle that is connected to the light inlet 141 and the light outlet 142, there is a deflector 44 that integrally bends and extends from the cage 40. The deflector 44 has a deflecting surface 441 that faces toward both the light inlet 141 and the light outlet 142.

As depicted, there is a notch 411 on the rear end of roof 41 of the cage 40. The deflector 44 is formed by bending and extending from the inner edge of the notch 411. The arm 12 of the housing 10 has a wear slot 121 in a position corresponding to the deflector 44. The deflector 44 extends to the intersection angle of the light channel 14 through the notch 121.

The receptacle connector 1 can be installed on a circuit board 7, forming a connector system. A light source 8 is installed on the upper surface of the circuit board 7. The circuit board 7 has an installation opening 71, a plurality of sockets 72 and 73 and a plurality of fastening holes 74, wherein the light source 8 is, without limitation, a light emitting diode.

When the receptacle connector 1 is installed on the circuit board 7, the receptacle connector 1 subsides and is assembled in the installation opening 71, thus forming a subsiding sheet design. First and second welded parts 213 and 312 of various first and second terminals 21 and 32 are correspondingly plugged into the socket 72 and 73, allowing the receptacle connector 1 to be electrically connected to the preset circuit of the circuit board 7. Various anchor pins 431 of the metal case and 40 are correspondingly plugged and affixed into fixation holes 74 of the circuit board 7 or are further welded, so that the receptacle connector 1 is affixed onto the circuit board 7.

At this time, entrance 143 of light inlet 141 of receptacle connector 1 is faced to light source 8 of the circuit board 7. With this, light L from light source 8 is received via light inlet 141 and is deflected through light outlet 142 onto exit 144 due to the deflecting surface 441, thus enabling a visual indication effect. Thus, exit 144 faces in a direction opposite of the insertion direction and the deflecting surface 441 is at an intersection point of a first intersection angle formed between the light inlet 141 and the exit 144 (this first intersection angle may be less than 90 degrees, as depicted, in certain embodiments).

In addition, receptacle connector 1 of the present invention can also add another light channel on the other arm 12 (not shown in the figures) and another corresponding deflector (not shown in the figures) can bend and extend integrally from cage 40, in order to correspondingly deflect light from another light source installed on circuit board 7, thus achieving a dual visual indication effect.

In addition, when receptacle connector 1 is plugged into a corresponding plug connector (not shown in the figures), the control circuit of circuit board 7 may actuate the light source 8 (the as a light emitting diode), so as to cause the state of light source 8 to emit light, go off, flash or change the color emitted and the change of state of light source 8 can be performed based on need according to the detection and set up of the circuit.

The depicted receptacle connector 1 is a right angle receptacle connector and has a compound eSATA/USB terminal structure. In a modified embodiment, the structural design of the aforementioned light channel 14 and deflector 44 can similarly be applied an oblique angle receptacle connector (not shown in the figures) that runs oblique to circuit board 7. In such an embodiment, the corresponding intersection angle would be greater than 90°.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

1. A receptacle connector, comprising:
a housing, the housing including a base and two arms that extend from the two sides of the base and a tongue the extends from the base; wherein one of the two arms has alight channel and the light channel includes a light inlet and a light outlet that form an intersection angle and that are in communication with each other;
a plurality of terminals, positioned on the tongue;
a cage assembled with the housing, wherein the combination of the housing and the cage forms a socket on a front end that is aligned with a first insertion direction and the cage includes an exit that is in communication with the light outlet, wherein the exit faces in a direction opposite the first insertion direction; and
a deflector that integrally bends and extends from the cage; the deflector having a deflecting surface that is at an intersection point between the light inlet and the exit.

2. The receptacle connector according to claim 1, wherein the intersection angle between the light inlet and the exit is less than 90°.

3. The receptacle connector according to claim 1, wherein the cage comprises a roof, a bottom and two side walls that are connected to the roof and the bottom; wherein the a roof has a notch and the a deflector is extends from an inner edge of the a notch.

4. The receptacle connector according to claim 3, wherein the a tongue has a first surface and a second surface opposite each other; the terminals comprises a first terminal set and a second terminal set; the a first terminal set is placed on the first surface; the first terminal set is configured to comply with the universal serial bus signal (USB) transmission protocol and the second terminal positioned on the second surface; the second terminal set is configured to comply with External Serial Advanced Technology Attachment (eSATA) signal transmission protocol.

5. A connector system comprising:
the receptacle connector of claim 1, and
a circuit board with a light source, the receptacle connector mounted on the circuit board such that the light inlet is aligned with the light inlet.

6. The system of claim 5, wherein the light source is a light emitting diode.

7. The system of claim 6, wherein the receptacle circuit board is configured to modify the light emitted from the light source when, in operation, a mating plug is inserted into the socket.

8. The system of claim 5, wherein the receptacle is configured so that the socket extends on both sides of the circuit board.
